(19) United States
(12) Patent Application Publication
(10) Pub. No.: US 2014/0094936 A1
(43) Pub. Date: Apr. 3, 2014

(54) Multi-function touch screen wall switch with video sensor system, wifi connectivity, and other integrated sensor systems

(71) Applicant: Brent E Saunders, Park City, UT (US)

(72) Inventor: Brent E Saunders, Park City, UT (US)

(21) Appl. No.: 13/573,622

(22) Filed: Sep. 28, 2012

(51) Int. Cl. G05B 19/02

(52) U.S. Cl. CPC G05B 19/02
USPC 700/17

(57) ABSTRACT

A method is provided to simplify programmable control of and/or other electrical devices of at least a portion of at least one room in a building structure. A multi-touch flat panel switch with integrated sensors is adapted to e mounted in a receptacle in the building structure. The switch is Wi-Fi enabled so that function can be controlled by devices connected over a local area network or the Internet. The switch includes a multi-touch screen, sensors (photographic camera, microphone, speaker, infra-red, motion, proximity, temperature) and at least one microprocessor. Signals from the sensors are utilized to control a connected fixture and/or other electrical device.

This invention relates to electrical control and display systems.

More particularly, the invention relates to methods and apparatus to control the lights and other electrical devices in a building structure by utilizing an existing wired light switch receptacle box.

Those of skill in the art have for many years attempted to provide methods and apparatus to control and display functions of the lighting, heating and cooling in a building structure and that of other attached or remote electrical devices.

Accordingly, it would be highly desirable to provide an improved method and apparatus to sense condition in a building structure so that living conditions in the building structure can be appropriately adjusted.

Therefore, it is a principal object of the instant invention to provide an improved control method and apparatus.

This and other, further and more specific objects and advantages of the invention will be apparent to those skilled in the art from the following detailed description thereof, taken in conjunction with the drawings, in which:

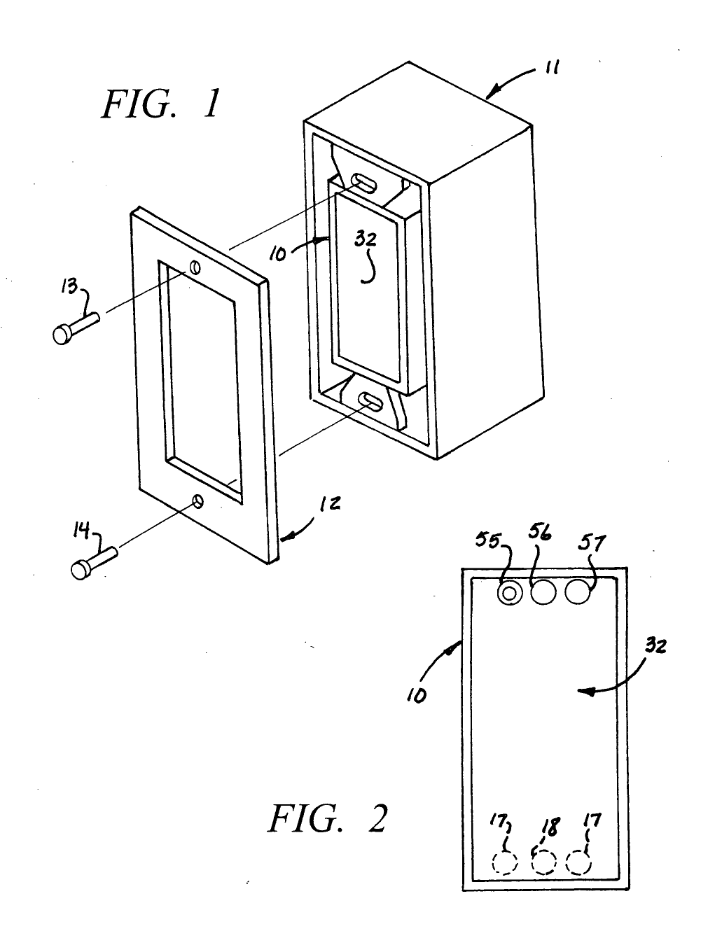

FIG. 1 is a perspective view illustrating a wired electrical wall switch which is constructed in accordance with the invention and which is in a wall mounted receptacle;

FIG. 2 is a front view of the switch of FIG. 1 illustrating additional construction details thereof;

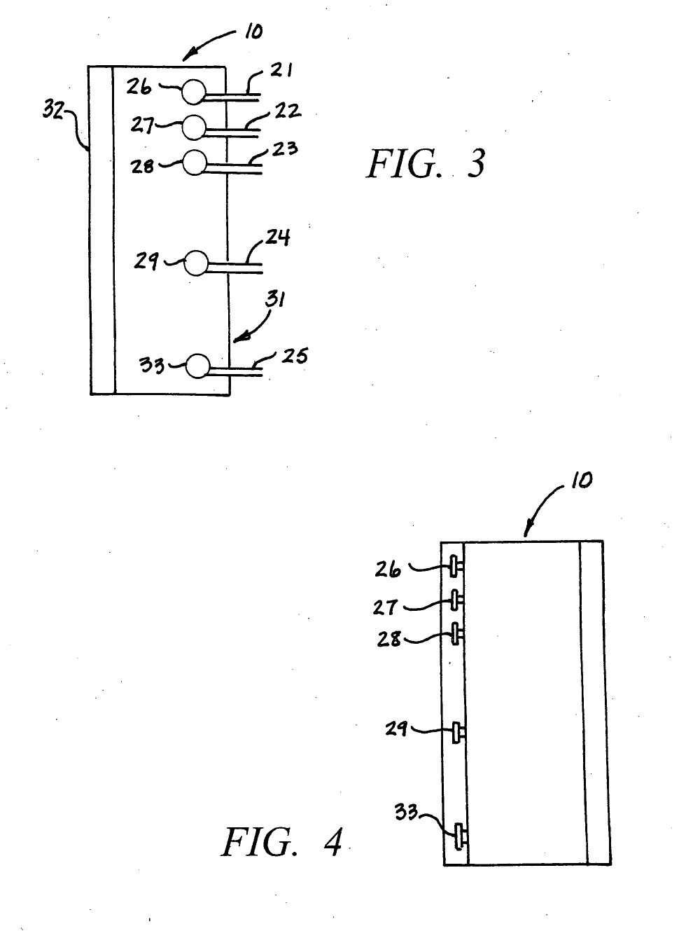

FIG. 3 is a side view of the switch of FIG. 1 illustrating additional construction details thereof;

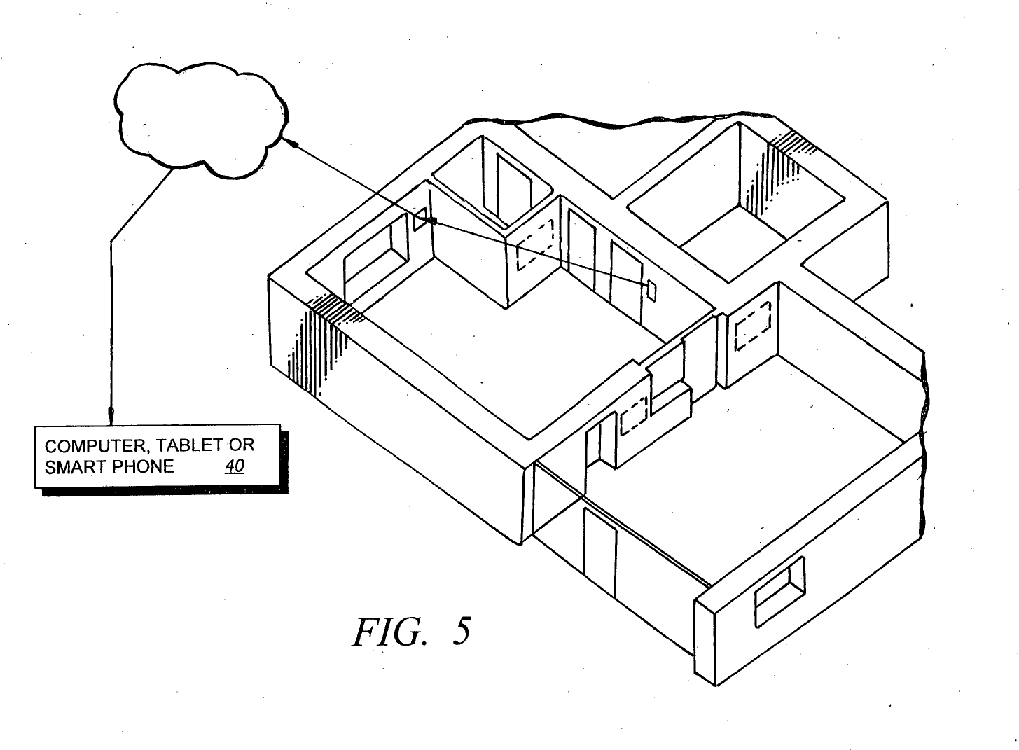

FIG. 4 is a back view of the switch of FIG. 1 illustrating additional construction details thereof;

FIG. 5 is a partial perspective view of a building structure illustrating the mode of operation of the invention; and,

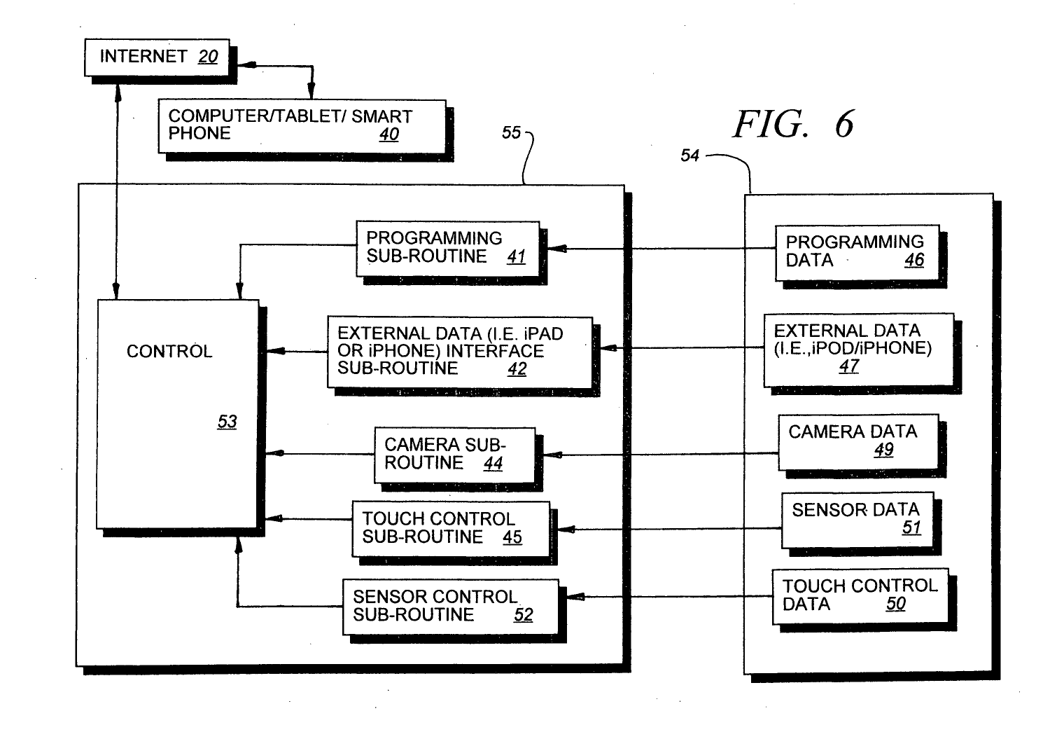

FIG. 6 is a block diagram illustrating a microprocessor which can be an integral part of a light switch constructed in accordance with the invention.

Briefly, in accordance with the invention, I provide an improved method to control at least a single fixture or electrical device in at least one room in a building structure. The building structure includes at least one fixture or electrical device in the room; at least one switch receptacle in the room including wiring connecting the receptacle to the fixture or device. The improved method includes the step of providing a switch shaped and dimensioned to be mounted in and fastened to the switch receptacle. The switch includes a touch screen to manually turn electricity to the fixture on and off; a video camera mounted in said switch to generate primary signals representing at least a portion of the room; and, a microprocessor mounted in the switch to receive and analyze the signals to generate secondary signals to control the switch to automatically turn electricity to the fixture on and off. The method also includes the step of mounting the switch in the receptacle and connecting the wiring at the receptacle to the switch; and, utilizing the primary signals generated by the camera to generate the secondary signals to control the switch.

In another embodiment of the invention, I provide an improved method to control at least a single fixture or electrical device in at least one room in a building structure. The building structure includes at least one fixture in the room, at least one switch receptacle in the room, and an auxiliary system. The improved method comprises the step of providing a switch shaped and dimensioned to be mounted in and fastened to the switch receptacle. The switch includes a touch screen to manually turn electricity to the fixture on and off; a camera mounted in the switch to generate primary signals representing at least a portion of the room; and, a microprocessor mounted in the switch. The microprocessor receives and analyzes the primary signals to generate secondary signals to control the auxiliary system. The method also includes the steps of mounting the switch in the receptacle and connecting the wiring at the receptacle to the switch; and, utilizing the primary signals generated by said camera to generate the secondary signals to control the auxiliary system. The auxiliary system can be another switch, a light fixture, an electrical plug or connected device, an alarm system, an air conditioning system, a locking system, etc.

Turning now to the drawings, which depict the presently preferred embodiments of the invention for the purpose of illustrating the practice thereof and not by way of limitation of the scope of the invention and in which like reference characters refer to corresponding elements throughout the several views, FIG. 1 illustrates a switch 10 constructed in accordance with the principles of the invention and mounted in a switch receptacle 11, typically but not necessarily a pre-existing wired switch receptacle. Receptacle 11 is mounted in an opening formed in a wall 64 in the room 61 of a building structure 60 (FIG. 5). Procedures for mounting a receptacle 11 in the wall 64 of a building structure 60 are well known and are not detailed herein. Similarly, various fastener 13, 14 configurations for mounting switch 10 in a switch receptacle 11 are well known and are not detailed herein. After switch 10 is mounted in receptacle 11, fasteners 13 and 14 or other means are utilized to secure switch cover 12 to receptacle 11.

Switch 10 includes touch screen 16 on the front 32 of switch 10 and also includes camera lens/camera 56, speaker 55, and infrared sensor 57 (FIG. 2). Other sensors 17 can also be incorporated in switch 10. Layout and shape of sensors may be varied from the drawings.

The number of “poles” is the number of separate circuits which are controlled by a switch. For example, a “2-pole” switch has two separate identical sets of contacts controlled by the same knob. The number of “throws” is the number of separate positions that the switch can adopt. A single-throw switch has one pair of contacts that can either be closed or open. A double-throw switch has a contact which can be connected to one of three other contacts, etc.

A single pole, single throw switch is a simple on-off switch. The two terminals are either connected together or disconnected from each other.

A variety of switch wiring schemes are well known in the art and are not repeated here. In the embodiment of the invention illustrating in FIGS. 3 and 4, wires 21 to 25 are connected to terminals 26 to 29, 33, respectively. Wire 21 is typically a black wire, and is a “line” wire. Wire 27 is typically a white wire, and is “neutral” wire. Wire 23 typically is a red wire and is a “three way” wire. Wire 24 is a load wire. Wire 25 typically is a green wire and is a “ground” wire. The switch 10 in FIGS. 3 and 4 can be operated as a single pole switch or as a three way switch by appropriately configuring the electronics in switch 10 by, for example, integrating a bridge into switch 10.

While the construction and operation of touch screen 16 can vary as desired, in one preferred embodiment of the invention, screen 16 is of the general type found on iPhones and other similar devices. The fixture to which switch 10 is connected is turned on and off by touching a designated area of screen 16. When the fixture is on, the word “ON” appears in the designated area of touch screen 16 and is visible to a user. When the fixture is off, the word “OFF” appears in the designated area of screen 16. When an area of screen 16 different from that used to turn the light fixture on and off is touched, the words “WI-FI SETUP” and “ENTER” appear on screen 16. When “WI-FI SETUP” is touched, the first of a series of instructions/selections necessary to program switch 10 appears. The makeup and order of such instructions can vary widely. Such- instructions are typically found in wireless devices which connect to the Internet through a WiFi enable Internet gateway/router 63, are found when “APPS” are being set up for utilization on an iPad or similar device, are found when programs are being installed or programmed for use on a desktop computer, etc. Consequently, such a set of instructions is not detailed herein. It is sufficient to say that the instructions must permit switch 10 to be operated in the manner set forth herein.

Switch 10 includes a subsystem which allows Wi-Fi connection to the users Wi-Fi enabled gateway/router 63. When switch 10 is initially installed in a receptacle 11 and connected to the wires in receptacle 11, following Wi-Fi setup, the Wi-Fi unit connects switch 10 via a web site on the Internet 20 (FIG. 5). The user employs the touch screen 16 of switch 10 to enter a registration number and/or password while connected to the Internet to enable remote programmable features. The user may access switch functionality using a remote computer/tablet or smartphone 40. The user then has the ability to go, via his desk top computer or the microprocessor and touch screen 16 in switch 10 or via another computer, to the web site, to enter his registration number and/or password, and to enter instructions about the times of day and/or other parameters when the fixture connected to switch 10 is turned off and on. Basic function parameters are stored i the switch on-board processor to execute switch function. Switch parameters can be changed and updated from the Internet utilizing WiFi connectivity and as authorized from the user's account settings. Switch feedback is provided to an Internet based data server. An example of switch 10 function may automatically turn the switch 10 on or off, based on instructions from another Internet enabled device, including but not limited to geographic proximity of the other device to the switch 10. In another embodiment of the invention, the requisite times of day are stored in a microprocessor mounted in switch 10, and the microprocessor automatically turns the switch 10 on or off, as appropriate, at the proper times of a predetermined schedule, detected motion, light, proximity, etc.

The audio speaker 55 permits music, voice, or other audio signals from remote computer 40 or another desired source to be broadcast over speaker 55. Similarly, music or other audio signals stored in a microprocessor mounted in switch 10 can be broadcast over speaker 55 at desired or programmed times of day. Integrated microphone 18 in switch 10 can also receive audio input signals.

Primary sensory input to the switch 10 is provided via an integrated video camera 56. The camera output data is evaluated by the switch 10 onboard processor. After onboard processor analyzation of video data, it may be determined that changes have occurred in room 62 that could be interpreted relative to object motion, object proximity, object position and direction, lightness, darkness, etc. The result of onboard processor analysis is then utilized by the switch and/or remote Internet server to provide instructions for the switch to turn off or on. Other sensors such as infrared sensor 57 detect movement (i.e. warmth) from a human body, a motion sensor detects movement of an object in front of the switch, a microphone sensor detects the presence or absence of sounds. These and any other sensors provide feedback data to the onboard processor and/or remote Internet server to provide instructions for the switch to turn off or on.

“APP” programs are computer programs which are provided to be purchased or otherwise obtained and utilized in conjunction with switch 10. Such an app program can be stored in a microprocessor in switch 10 and accessed and operated using touch screen 16, or can be stored in a remote device such as a computer, iPhone, iPad or other smartphone device 40 which communicates via the Internet 20 with switch 10. One such app program allows the predominant color or colors display on screen 16 to be altered so the color of screen 16 complements or is equivalent to the color(s) used to paint or decorate the wall 64 or to the color(s) used to otherwise decorate the room 61. If the app program is maintained in computer 40, the app program is accessed via the Internet 20 via a user's desktop or other computer located in structure 60. The color selected by the user is transmitted by computer 40 to switch 10 so that the display screen 16 uses the selected color.

One function of a microprocessor mounted in switch 10 is to permit a user to employ touch screen 16 to register an offsite server via the Internet 20. During the registration procedure, a user can in conventional fashion, input a password and registration or ID number with computer 40 and/or with the microprocessor mounted in switch 10. Switch 10 can include a backup battery to power switch 10 in the event of a power failure.

Camera 15, infrared sensor 13, or other sensors in switch 10 can be utilized for security purposes to detect the presence of an unauthorized individual in a room 61 of structure 60. An entry code is programmed or into the microprocessor in switch 10 and must, in order to avoid the activation of an alarm system, be entered in computer 40 or switch 10 by an individual entering room 61.

A microphone 18 can be included in switch 10 to detect voice signals or commands that could be utilized by “APPS” or other electronic devices to provide input which may allow control or modification of function of a remote device. The microphone can be utilized to receive voice commands or other audio to turn a programmed feature or the fixture on and off.

Switch 10 normally is powered by electricity provided by the various wiring 21, etc. which is connected to switch 10.

Switch 10 can communicate wirelessly or via hard wire with other switches in a building structure 60 to control the function of a group of fixtures, devices or other switches.

In one preferred embodiment of the invention, the camera 56 in switch 10 views at least a portion of the interior space 62 in a room 61 (FIG. 5). The signals produced by camera 56 are analyzed by the microprocessor in switch 10. If the “view” seen by camera 56 changes, then the microprocessor in switch or computer 40 presumes that someone is in the room and automatically utilizes switch 10 to turn on the light fixture operatively associated with switch 10.

In another preferred embodiment of the invention, the camera 56 in switch 10 views at least a portion of the interior space 62 in a room 61 (FIG. 5). The signals produced by camera 56 are analyzed by the microprocessor in switch 10. If the “view” seen by camera 56 changes such that the contrast or lack of contrast indicates that the room has become darker, then the microprocessor on switch 10 or computer 40 determines that it is night time and automatically utilizes switch 10 to turn on the fixture operatively associated with switch 10.

In a further preferred embodiment of the invention, the camera 56 in switch 10 includes a distance determination device (or switch 10 includes a distance sensor operatively associated with camera 56), and when camera 56 identifies a new object in the view of the camera which is closer (or further) from the camera 56 than had earlier been the case with other objects in view of the camera lens, then the microprocessor in switch 10 determine that an individual has entered the room and automatically uses switch 10 to turn on the fixture operatively associated with switch 10.

In still another preferred embodiment of the invention, the camera 56 in switch 10 views at least a portion of the interior space 62 in a room 61 (FIG. 5). The signals produced by camera 56 are analyzed by the microprocessor in switch 10. If the number of a particular color of pixels in a portion of the image produced by camera 56 changes, then the microprocessor in switch 10, as the case may be, presumes that someone is in the room and automatically utilizes switch 10 to turn on the fixture operatively associated with switch 10.

As would be appreciated by those of skill in the art, different features or steps of the apparatus and methodology described herein can be combined in any desired manner to produce different generic inventions. For example, in one such generic invention, a camera 56 with a distance measuring device and an “app” permitting the color of screen 16 to be changed can be combined in a switch 10. In another such generic invention, a camera 56 with a distance measuring device and a microprocessor program which analyzes pixel density (or densities) in one or more areas of the view “seen” by camera 56 can be combined in a switch 10. The fact that each feature in a combination comprising such a generic invention is not shown in a single drawing, but may appear in two or more separate drawings, does not alter the fact that the combination is a generic invention. If necessary, an additional drawing showing each feature in a combination can be submitted. Further, it is intended that each independent and dependent claim as originally filed comprise a generic invention. For example, a combination set forth in an originally filed independent claim is a generic invention. A combination which is set forth in one or more originally filed claims which depend on and from an originally filed independent claim is a generic invention. A combination which is set forth in an originally filed dependent claim and one or more originally filed claims which depend on and from the originally dependent claim is a generic invention.

FIG. 6 illustrates a microprocessor which can be incorporated in switch 10. The microprocessor includes a memory 54 and controller 55. Memory 54 includes programming data 46, iPod/iPhone data (i.e., external data) 47, thermostat data 48, camera data 49, touch control data 50, and sensor data 51. The controller 55 includes a programming sub-routine which enables switch 10 to be programmed from a remote computer/tablet or smartphone 40, or, to be programmed utilizing touch screen 16 in conjunction with the programming sub-routine 41. The programming sub-routine 41 can also be utilized to download (and operate) “APPS” from iTunes or other comparable web sites and to store the APPS in programming data 46.

The iPod/iPhone interface (i.e., external data interface) sub-routine 42 enables an iPad or iPhone or similar device to be utilized to program the microprocessor in switch 10 via an uniquely programmed “APP” on the remote computer/tablet or smartphone, and/or a remote computer/tablet or smartphone 40.

Camera sub-routine 44 operates camera 56, facilitates the transmission of camera signals to controller 55 and memory 54, or, to remote computer/tablet or smartphone 40. Sub-routine 44 also facilitate the analysis of camera signals.

Touch control sub-routine 45 is utilized to control the operation of screen 16 to turn an associated light fixture on and off, to program switch 10, and to download apps and other data to switch 10 or from switch 10 to remote computer/tablet or smartphone 40 or another desired source.

Sensor control sub-routine 52 operates infrared sensor 13, a motion sensor, or any other sensor 17 in switch 10.

The controller 55 preferably includes a transmitter/receiver such that control 53 can, by wi-fi or hard wire or any other desired communication means, communicate with the Internet 20, and the remote computer/tablet or smartphone 40.

Having described my invention in terms understandable to those of skill in the art, and having described the presently preferred embodiments and best mode thereof,

I claim:

1. A method to control an electrical device in at least one room in a building structure, the building structure including
at least one fixture in the room, and
at least one switch receptacle in the room including wiring connecting the receptacle to the fixture,
the method comprising the steps of
(a) providing a switch shaped and dimensioned to be mounted in and fastened to the switch receptacle, the switch including
(i) a touch screen to manually turn electricity to the fixture on and off,
(ii) a camera mounted in said switch to generate primary signals representing at least a portion of the room,
(iii) a microprocessor mounted in said switch to receive and analyze said primary signals to generate secondary signals to control said switch to automatically turn electricity to the fixture on and off,
(b) mounting said switch in said receptacle and connecting the wiring at the receptacle to said switch;
(c) utilizing said primary signals generated by said camera to generate said secondary signals to control said switch.

2. A method to control an electrical device in at least one room in a building structure, the building structure including
at least one fixture in the room,
at least one switch receptacle in the room,
an auxiliary system,
the method comprising the steps of
(a) providing a switch shaped and dimensioned to be mounted in and fastened to the switch receptacle, the switch including
(i) a touch screen to manually turn electricity to the fixture on and off,
(ii) a camera mounted in said switch to generate primary signals representing at least a portion of the room,
(iii) a microprocessor mounted in said switch to receive and analyze said primary signals to generate
secondary signals to control said auxiliary system,
(b) mounting said switch in said receptacle and connecting the wiring at the receptacle to said switch;
(c) utilizing said primary signals generated by said camera to generate said secondary signals to control said auxiliary system.
